(19) United States
(12) Patent Application Publication
(10) Pub. No.: US 2011/0206487 A1
(43) Pub. Date: Aug. 25, 2011

(54) Keg Handling Equipment

(76) Inventor: Terry George MORGAN, Seaford (AU)

(21) Appl. No.: 12/708,548

(22) Filed: Feb. 19, 2010

(51) Int. Cl. B60P 3/055; B60P 1/02; B60B 29/00

(52) U.S. Cl. 414/427; 414/539; 414/540

(57) ABSTRACT

A keg conveying trolley has a pair of wheels, a central post and a slide which carries a hook for grasping the keg rim. The slide is lockable at different keg heights. A foot plate assists in tipping the trolley to an inclined position for wheeling the keg from one place to another. The keg stacking version has a winch worked by hand or a cordless drill. The keg is supported by a rise and fall carriage. The carriage can be modified to be multitask. Variants can lift gas bottles on their side, truck tyres for placing on wheel studs and odd shaped loads.

### FIELD OF THE INVENTION

This invention concerns keg handling equipment.

### BACKGROUND OF THE INVENTION

In the hospitality industry the carriage of bulk beverages such as beer in kegs is commonplace. The kegs are substantially cylindrical with a central connection port in one circular end wall for joining the keg to the pipework in the dispensing area, namely a bar. The port is surrounded by a steel ring about 20 mm in diameter and this is embraced by an annular upstanding flange extending from the end wall of the keg. Two hand slots disposed at 180E are cut into the flange allowing the keg to be grasped.

Full kegs weigh 60-70 kg, the weight of an adult, and while staff can move empty kegs with relative ease and safety, the removal of full kegs firstly from the truck, from the truck to the dispense area and then within the dispense area is a task requiring specialised equipment. It is common for kegs to be stacked one on top of the other in the dispense area and while it is possible for two men to lift a full keg, in doing so they exceed the safe legal workplace lift of 25 kg. Female staff naturally find such lifting strenuous and delivery staff who handle many kegs in the course of a working day eventually incur injury. Back injuries are expensive for any industry. Kegs may cause leg and foot injuries when they are thrown from the truck onto a tyre or pad on the pavement. If kegs are dropped even a short distance, their mass is sufficient to crack tiled floors and to damage vinyl floor coverings.

The kegs are stacked on the delivery truck in two tiers with a strip of plywood between them. Once at ground level they are placed on a pallet which is then lifted by a small forklift truck with rear steered wheels. The forklift transports the kegs along pavements through corridors and doorways to the dispense area. The top row of kegs are lowered to the ground level where a keg trolley is used to wheel a keg to the final position required. This trolley has two wheels and two hooks, one for each capacity of keg.

### SUMMARY OF THE INVENTION

The first apparatus aspect of the invention provides a hand trolley of the type having an upright wheeled spine, with manually operable means to engage a load for the purpose of conveying the load and to disengage the load when required.

In a preferred embodiment, the means is a pivotable hook. The hook is lockable once the load is engaged. The hook is operable to engage the rim of a keg. The means is height adjustable in order to suit the load type, for example there are three keg heights in the liquor trade. The means is lockable at three different heights corresponding to the three prevailing keg heights. The hook is suspended from a slide which engages the spine and stops define the slide travel. The spine may be a frame with two uprights but we have found a single metal post adequate for kegs.

The second apparatus aspect of the invention provides a load handling trolley comprising a trolley frame or base, an upstanding post extending from the frame or base, a rise and fall carriage which rides on the post, means associated with the carriage to engage the load, and a winch for the carriage.

In a preferred embodiment, the means to engage the load is a hook extending from the carriage and a cradle member below the hook supports a keg. The winch is at or near the top of the post. A front pair of wheels lies in front of the post to leave a load space between the wheels and the rear pair of wheels are castors. The trolley is steered by a push bar extending from the frame or base behind the post and the push bar has a mount for counterweights.

In another embodiment, the winch has a reduction gearbox and a socket for accepting drive from a pistol drill. The carriage can be modified to be multipurpose. It may have one or more mounts for bolt-on brackets which engage specific loads. The carriage has an attachable arm and a shell for lifting an industrial LPG gas bottle.

In a specialised application, the carriage has a cradle with horizontal rollers for supporting a truck wheel in the upright position for presentation to waiting wheel studs. If the winch is to be manually operated it needs to be lowered to a more convenient height. In this version the push bar and the post unite to form a frame and the winch is supported on the push bar.

When high manoeuverability is needed, the front wheels are mounted for pivoting about a vertical axis and coupled for steering at 90E to the trolley axis. This allows the trolley to turn in its own length.

### BRIEF DESCRIPTION OF THE DRAWINGS

One embodiment of the invention is now described with reference to the accompanying drawings, in which:

FIG. 1 is a perspective of the trolley.

FIG. 2 is a side view of the sleeve fragment of FIG. 1, bearing the keg carrying hook in the “disengage” position.

FIG. 3 is a side view of the sleeve fragment of FIG. 1, bearing the keg carrying hook in the “engage” position.

FIG. 4 is a front view of the sleeve fragment of FIG. 1.

FIG. 5 is a perspective of a keg stacker with a hand winch.

FIG. 6 is a perspective of a keg lifter with a cordless drill winch drive.

FIG. 7 is a perspective of a truck wheel lifter.

FIG. 8 is a perspective of a gas bottle lifter.

FIG. 9 is a perspective of the carriage fragment showing modification for different loads.

FIG. 10 is a perspective of a fragment of the trolley showing front wheel steering.

FIG. 11 is the same view as FIG. 10 but with the steering turned through 90E.

### DETAILED DESCRIPTION WITH RESPECT TO THE DRAWINGS

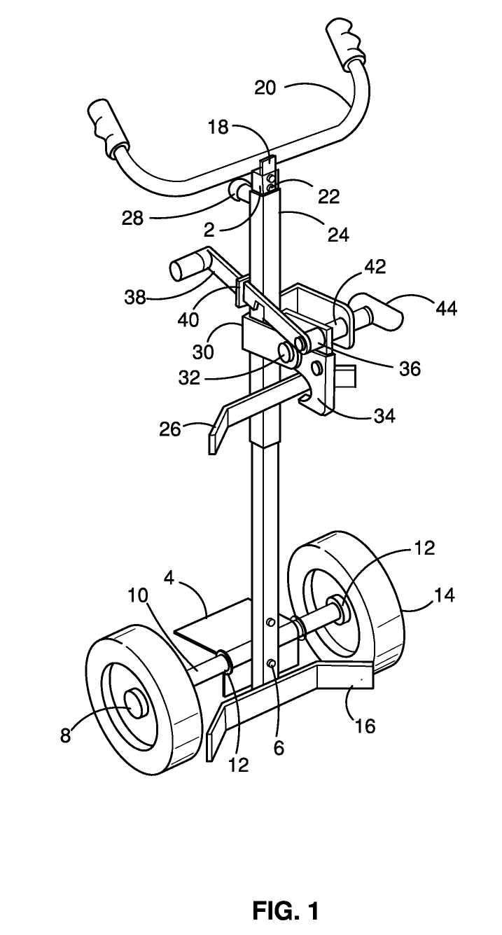

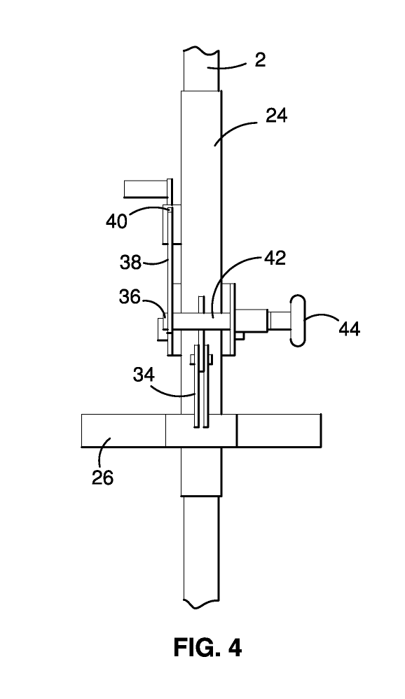

Referring now to FIGS. 1-4, the steel, square tube spine 2 has an L-section foot plate 4 with an upright lug (not shown) secured by bolts 6. Axle 8 is welded to the hidden faces of plate 4. Tubular spacers 10 sit between washers 12 and wheels 14. A lower cradle member 16 is welded at the lower end of spine 2 which also acts as a trolley stand.

The upper end of spine 2 receives a pair of lugs 18 to which handle bars 20 are fixed. This steering assembly is secured by bolts 22. The spine has three bores at the three lifting heights of the trolley.

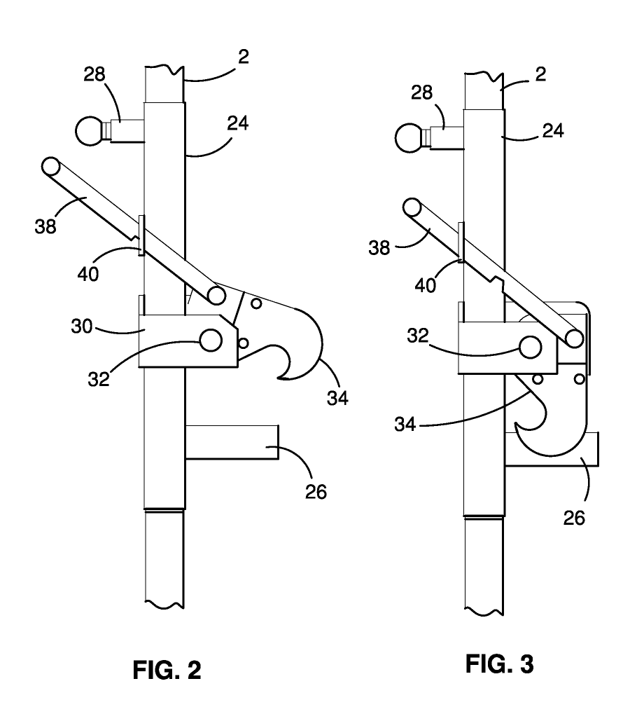

Sleeve 24 (600 mm) is a larger steel tube and is a loose fit on spine 2. The lower end of the sleeve carries upper cradle member 26. The upper end of the sleeve carries a spring loaded plunger 28 which enters one of the three bores (the topmost in FIG. 1). The central part of the sleeve supports an asymmetric channel bracket 30. Pin 32 turns in the bracket allowing claw 34 to tilt towards and away from the spine. The claw end is made of two side by side pieces to divide the wear caused by engaging the rim of a beer keg. The claw has a crank pin 36, one end of which is operated by a push/pull control arm 38. Slot 40 allows the arm to be parked in the “disengaged” position shown in FIG. 2. The opposite end 42 of crank pin 36 is hollow and in the “engaged” position shown in FIG. 3 lies in register with spring loaded plunger 44 mounted on channel bracket 30.

In use the trolley is wheeled up to a keg standing on the floor. The sleeve height is adjusted such that both cradles contact the keg. The control arm drops the claw which engages the beaded rim of the keg. The plunger 44 is released if there is any risk of a bump or mishap in order to lock the claw in the “engaged” position. The handlebar is tilted backwards at the same time as the foot plate is pressed down. The keg tilts and leaves the ground. The handlebar steers the trolley to its destination. If the plunger 44 is not used the claw will retain the keg because gravity biases the claw to the “engaged” position and the mass of the keg reacts against the cradle.

We have found the advantages of the above embodiment to be:

1. The claw grips the keg at any point on the circular rim except at the two handle areas.

2. The claw will not release the keg until the operator actuates the release so accidental releases are obviated.

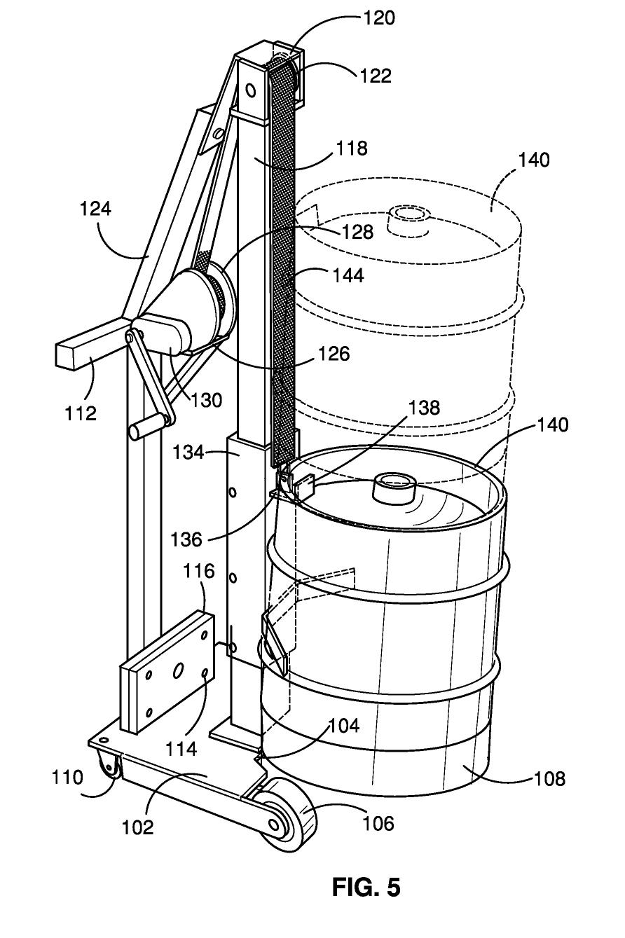

Referring now to FIG. 5, base 102 is made from laser cut steel plate which is bent to the shape shown. Cut out 104 separates the front pair of tyred wheels 106 to create a standing space for keg 108. The rear pair of wheels 110 are castors. A T-bar 112 is bolted to the base midway between the castors. The upright has a carrier pin 114 for cast iron or steel counterweights 116. The T-bar allows the operator to steer the trolley up to row of kegs and select one for lifting. This trolley is useful in the dispense area where kegs are stored together, one standing upon another using a keg centering device for ensuring the superimposed keg registers with the one below.

Central tubular steel mast 118 is 2 m high and supports a pulley mount 120 with a single pulley 122. The pulley mount is connected to the top of the T-bar by a steel strap tie 124. A shelf 126 extends from the T-bar and a winch 128 and gearbox 130 are bolted to the shelf. The winch is turned by a crank 132 whose axis is about 1100 mm above the floor.

The channel section carriage 134 is a loose fit on the mast and utilises graphite impregnated pads between it and the mast. Hook 136 extends from the carriage to reach through the handle cutout 138 of the keg 108 and engages the rim tube 140 thereof. Cradle arms 142 embrace the keg. Polyester tape 144 connects the carriage to the winch. The carriage moves about the height of a keg, the purpose being to achieve the stacking and unstacking shown in FIG. 5.

In a variant, the hand winch is substituted by a winch and worm gearbox powered by a 12 v vehicle battery which sits on the base and acts as a counterweight.

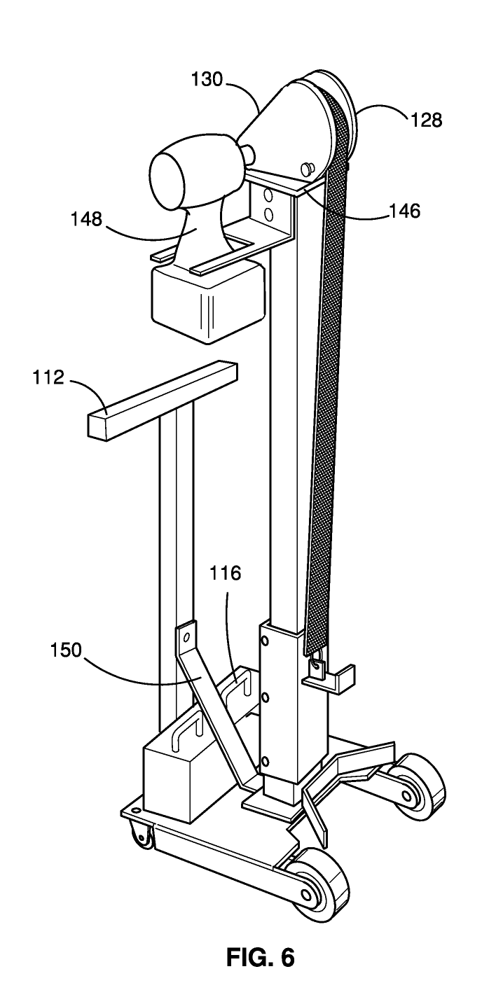

Referring now to FIG. 6, the top of the mast has a mounting plate 146 with a bifurcated drill bracket. Winch 128 and gearbox 130 are fixed to the plate 146 while the chuck of cordless pistol drill 148 drives the input of gearbox 130. T-bar 112 is strengthened by brace 150.

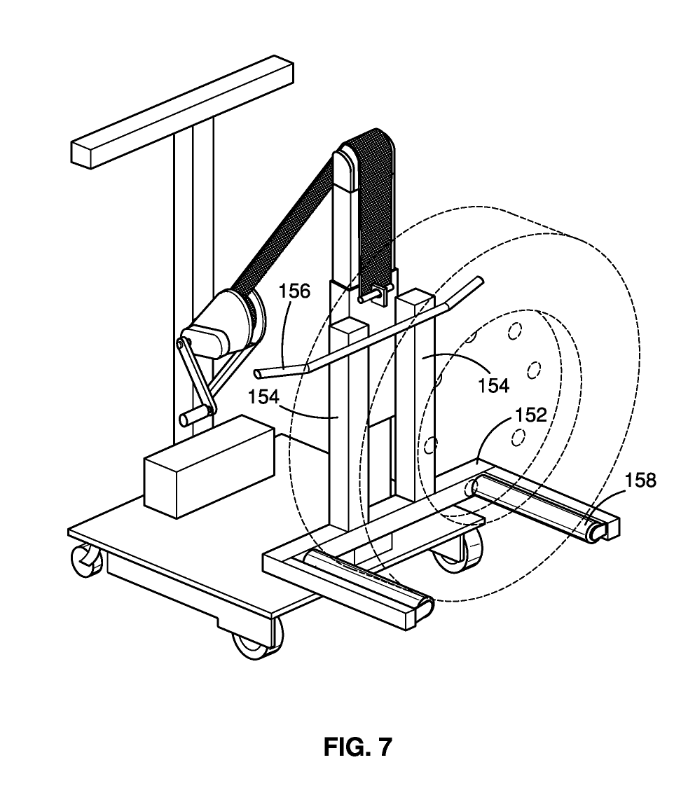

Referring now to FIG. 7, the trolley is similar in construction to that shown in FIG. 5 but the carriage is modified by the addition of a truck wheel support assembly consisting of a horizontal C-shaped cradle 152 suspended beneath the carriage by a pair of drop arms 154. Bar 156 acts as a wheel prop while rollers 158 allow the supported tyre to rotate in order to move the hub bores into register with the waiting wheel studs.

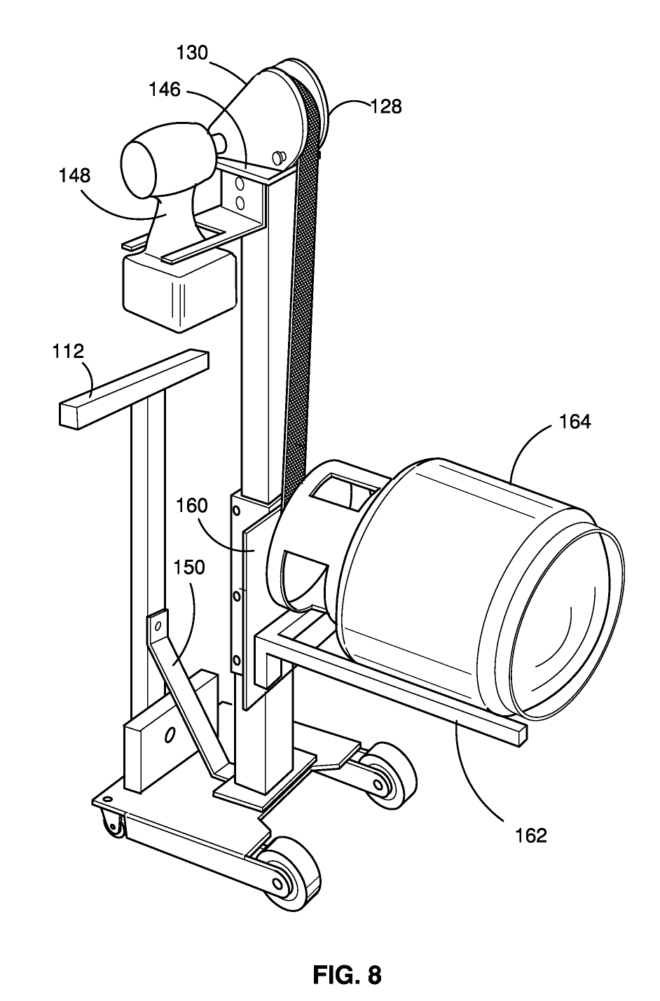

Referring now to FIG. 8, the trolley is similar to the version of FIG. 6 but the carriage is modified by the addition of an attached vertical plate 160 from which a C-shaped horizontal cradle 162 extends. Gas bottle 164 is tipped on its side to lie in the cradle. It can be secured by an encircling strap.

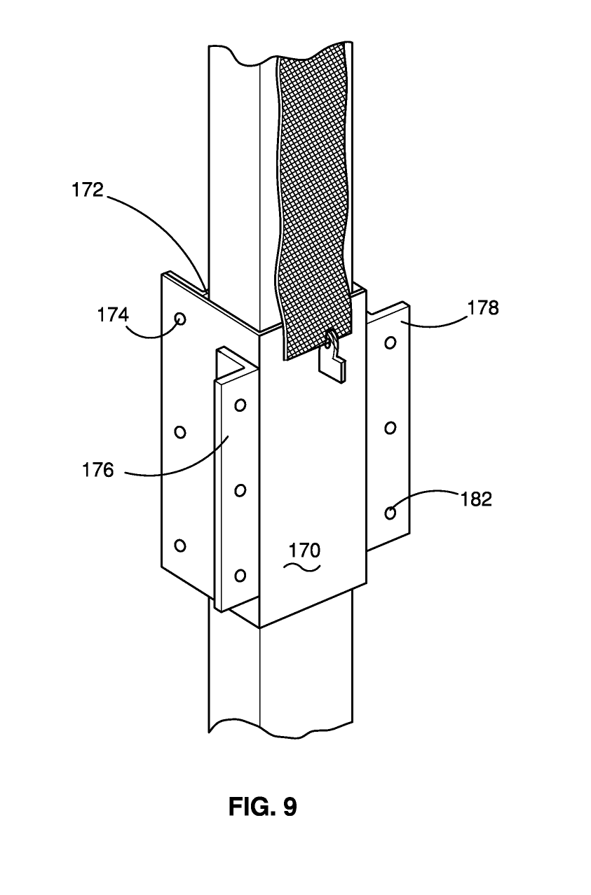

Referring now to FIG. 9, the construction of carriage 134 can be seen. Major channel 170 is closed by minor channel 1172. Fasteners 174 give access to the internal pads (not shown). Two pieces of angle iron 176, 178 are welded to the sides so that their faces lie flush with the wall 180 of the major channel 170.

Bores 182 allow bottom brackets or specially shaped mounts to be secured thereto. These in turn allow the trolley to be modified to assist with a variety of construction or fitting jobs where components are raised, lowered or held motionless while ancillary operations are performed.

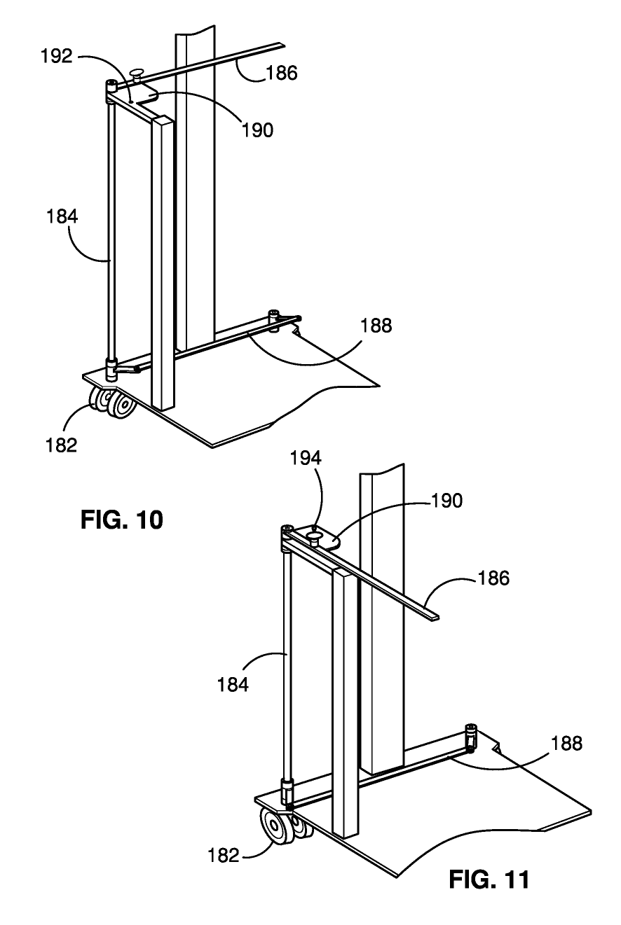

In FIGS. 9 and 10, the wheels of the trolley are modified. The front wheels, which are followed by the rear castors as the trolley travels, are replaced by swivel wheels 182 (one shown), the direction of which is controlled by rod 184 and steering arm 186. The opposite swivel wheel direction is rendered parallel by link 188. Quadrant plate 190 has stops 192, 194 for steering arm 186 sending the trolley straight ahead or allowing it to turn 90E in its own length. This is a useful capability in sites where loads must be precisely positioned.

In another embodiment, the carriage has a pair of ball bearings which are mounted on the front of the carriage and contact the port through windows cut in the carriage. A like pair on the lower rear part of the carriage balance the forces and together with the pads, promote low friction operation.

We have found the advantages of the above embodiment to be:

1. The trolley is versatile in that the carriage can cope with transverse loads such as building components, metal safes and odd shaped loads.

2. The trolley is more manoeuvrable than prior art trolleys.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1. A hand trolley of the type having an upright wheeled spine, and a push bar behind the spine, a pivotable hook extending from the spine which is manually operable to engage a load while the trolley tilts and wheels the load, and to release the load when required.

2. (canceled)

3. A hand trolley as claimed in claim 1, wherein the hook is lockable once the load is engaged.

4. A hand trolley as claimed in claim 1, wherein the hook is operable to engage the rim of a keg.

5. A hand trolley as claimed in claim 1, wherein the hook is height adjustable.

6. A hand trolley as claimed in claim 5, wherein the hook is lockable at multiple heights corresponding to the prevailing keg heights.

7. A hand trolley as claimed in claim 5, wherein the hook is suspended from a slide which engages the spine and stops define the slide travel.

8. A load handling trolley comprising a trolley frame or base, an upstanding post extending from the frame or base, a rise and fall carriage which rides on the post, means associated with the carriage to engage the load, and a winch for the carriage, and wherein the carriage has one or more mounts for bolt-on brackets which engage specific loads.

9. A load handling trolley as claimed in claim 8, wherein the means to engage the load is a hook extending from the carriage and a cradle member below the hook for supporting a keg.

10. A load handling trolley as claimed in claim 8, wherein the winch is at or near the top of the post.

11. A load handling trolley as claimed in claim 8, wherein a front pair of wheels lies in front of the post to leave a load space between the wheels and the rear pair of wheels are castors.

12. A load handling trolley as claimed in claim 8, wherein the trolley is steered by a push bar extending from the frame or base behind the post.

13. A load handling trolley as claimed in claim 12, wherein the push bar has a mount for counterweights.

14. A load handling trolley as claimed in claim 8, wherein the winch has a reduction gearbox and a socket for accepting drive from a pistol drill.

15. (canceled)

16. A load handling trolley as claimed in claim 8, wherein the carriage has an attachable arm and a shell for lifting an industrial LPG gas bottle.

17. A load handling trolley as claimed in claim 8, wherein the carriage has a cradle with horizontal rollers for supporting a truck wheel in the upright position for presentation to waiting wheel studs.

18. A load handling trolley as claimed in claim 12, wherein the push bar and the post unite to form a frame and the winch is supported on the push bar.

19. A load handling trolley as claimed in claim 8, wherein the front wheels are mounted for pivoting about a vertical axis and coupled for steering at 90E to the trolley axis.
